(19) United States
(12) Patent Application Publication
(10) Pub. No.: US 2008/0155690 A1
(43) Pub. Date: Jun. 26, 2008

(54) System and Method for Authenticating and Validating the Linkage Between Input Files and Output Files in a Computational Process

(76) Inventors: Yuval Broshy, Ramat Gan (IL); Dani Rosenthal, Raanana (IL); Ofer Feldman, Karme Yosef (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/575,753

(22) PCT Filed: Oct. 2, 2005
(86) PCT No.: PCT/IL05/01058

§ 371 Date: Mar. 22, 2007

(30) Foreign Application Priority Data
Oct. 14, 2004 (IL) 164571

(51) Int. Cl. G06F 11/30

(52) U.S. Cl. 726/22

(57) ABSTRACT

Provided is an automatic solution for authenticating and validating the unique linkage between input files and output target files in computational processes, regardless of their structure and regardless of the software used to process them. In particularly it relates to automatic authentication and validation of the linkage between source code files and resulted executable files in compilation linkage processes used for software creation.

### BACKGROUND OF THE INVENTION

1. Field of the Invention

The present invention relates to the field of authentication and validation of input files and their unique involvement in the creation of output files by computational processes. In particularly it relates to automatic authentication and validation of the linkage between source code files and executable files in compilation processes during creation of software.

2. Art Background

In computational processes an input file is converted and manipulated by software program according to internal programmed instructions and the results are written to an output target file that is saved for later uses. It is a known fact among software professionals, that it is very difficult to know by looking at a data input file and a random target file whether that input file has actually been used for creating that target file and if so—whether it was the only input file used. This can be done in some simple cases if the examiner has prior technical information on how the software operates and the files are structured in a comprehensible way, but in most cases it is a tormenting task. The task approaches impossibility when the software operation involves modes of artificial intelligence, optimization, translation and encryption, as is the case in communication software, database software, compilers etc.

The compiler case is especially noticeable and important because of its unique implications on the software industry. The input source files are written in human-readable form, commonly referred to as source code, and are translated by special software, called compiler, into machine language files, commonly referred to as object code. Usually several related object code files are linked together by software, commonly referred to as linker, to form the final version of a new software package, commonly known as executables, that can be sold to customers. Through the process the ability to identify the originating source code by looking at the resulting object code or final software executables is lost and reverse engineering is close to impossible. It is known among professionals in the art that customers often require that copies of the source code and other related source files be kept in the hands of a trusted third party—for any eventuality that some calamity will happen to the software creator and he will be unable to support his software. That third party, known in the art as software-escrow agent, gets copies of the source code and of the object code or the executable from the creator and places them in a safe place until a release event occurs as legally agreed between the parties. For the reasons explained hereinabove, the biggest problem facing the customer and the escrow agent is that they are totally depended on the software creator to provide the complete set of correct up-to-date source code files. The only practical way to check everything is to go to the software creator's office and monitor the software while it is being compiled and linked and immediately create copies of the source code files after the software has been finalized. Such practice is very expensive and labor intensive and is also subject to human errors and fraud. Another problem that faces the escrow arrangement users is that software developers are very reluctant to risk exposure of their technology by giving anybody, even a trusted entity, access to the source code files, thus increasing the uncertainty and unreliability of that approach.

In prior art, the only method available to alleviate some of the trust- or security concerns discussed hereinabove is encryption of the source code files either by the software developer or by the escrow agent to prevent technology leakage. Evidently this further hampers the customer or the escrow agent in ascertaining that all the right source files for the software are kept in escrow deposit.

It will be apparent that the same problem applies to any input file that is going through calculations by any program, or process, that outputs any target files.

The invention disclosed herein is of an automatic reliable solution for authenticating and validating the unique linkage between input files and output target files regardless of their structure and regardless of the software program used to process them.

### Definitions

The following terms are used in the present application as defined hereinbelow.

Input file: Plurality of data- or source code files that contain information to be fed to the CEP computational process.

CEP: Compiling or Encoding Program; a computer program, embodying one or more software processes, used by the operator to perform computational process on input files, which results in an output target files.

Target file: Plurality of files which are the output result of the computational process done by the CEP.

FMP: File Monitoring Program, a computer program, which is part of the present invention, that monitors, authenticates and validates all activities of files and processes done by the computer at any given time during its operation.

Digital Signature: A mathematical method, well known in the art, that gives any given group of information bits a unique identifier, which enables detection of any change in the group.

Encryption: A mathematical method, well known in the art, that ciphers any message by using a cipher key.

Symmetrical key: A cipher key that can be used for both encryption and decryption of the message.

Public key and Private key: A ciphering method, well known in the art, that enables encryption of a message with publicly known public key and decryption of the message by only the holder of the matching private key.

AVP: Archive Verification Program; a computer program, which is part of the present invention, that is used to verify that a particular set of input files was used to create a given set of target files and that the whole archive was not tampered with.

Attributes: Any or all characteristics of a digital file that distinguishes it and can be used in identifying it. For example but not limited to, name, time, date, size, digital signature, storage location, structure, topology, content, its creating program, etc.

The acronyms given hereinabove were given for the sole purpose of text and description simplification, as such they should not imply of any other meaning.

### BRIEF SUMMARY OF THE INVENTION

According to the present invention, there is disclosed a system and method that monitors all activities on a computer in order to authenticate and validate the linkage between input and target files of any given software. First part of the present invention is of the monitoring program, FMP, that identifies each and every file operation and its activating process and registers it to a log file together with its attributes. Furthermore, said program makes a digital signature of each encountered file and registers it to a log file. When monitored processes have finished, the program analyzes the activities of all the relevant input and target files by checking which process used them, in any way whatsoever, according to a preset set of rules. However, some checks are done by the FMP concurrently with the main processes, i.e. “on the fly”, in order to further ensure that no attempts are made to alter the files and mislead the monitor. In addition, the program analyzes, according to a preset set of rules, whether the same processes also created the registered target files. That is done by comparing their attributes to a predefined set of attributes and conditions stored in the FMP's database. It should be noted that any deviation from the rules indicate an abnormal way in which the target files were created—for example, by illegal dummy process—with the intention of forging the target file. Such indication will cause the program to issue a fail warning. On the other hand, if everything was according to the rules, the program will archive all the input files, target files and log file, with their attributes, for safe keeping; this authenticates the linkage between the input files and target files, i.e. that they were all used and created under the watchful eye of the FMP in one session.

Verification of the archive is done, according to the second part of the present invention, by means of the AVP, which reads each file from the archive and compares its attributes and digital signature to that registered in the log file. Any discrepancies will show that an attempt was made to manipulate the archived files or that they were damaged during storage—either physically or by virus etc.

It will be appreciated that encryption can be used to enhance security of any or all the stages described hereinabove.

### BRIEF DESCRIPTION OF THE DRAWINGS

FIG. 1 is a schematic flow chart, showing a single input file being processed by the CEP, resulting in a single target file, according to prior art;

FIG. 2 is a schematic flow chart, showing a plurality of input files being processed by the CEP, resulting in target files, according to prior art;

FIG. 3A is a block diagram of a preferred embodiment of a system for creating target files through a CEP, including an FMP and files archive according to the present invention;

FIG. 3B is a block diagram of a preferred embodiment of an archived files verification system, including an AVP, according to the present invention;

FIG. 4 is a flow diagram of the monitoring, analyzing and validation processes for the system of FIG. 3A.;

FIG. 5 is similar to FIG. 4, but including encryption of all records and files;

FIG. 6 is similar to FIG. 5, but with the FMP being integrated with the CEP as one unified comprehensive software system;

FIG. 7 is a flow diagram of the files verification process of the AVP system of FIG. 3B; and

FIG. 8 is an illustration of the FMP or AVP results report after a compilation-linkage program run.

### DETAILED DESCRIPTION OF THE INVENTION

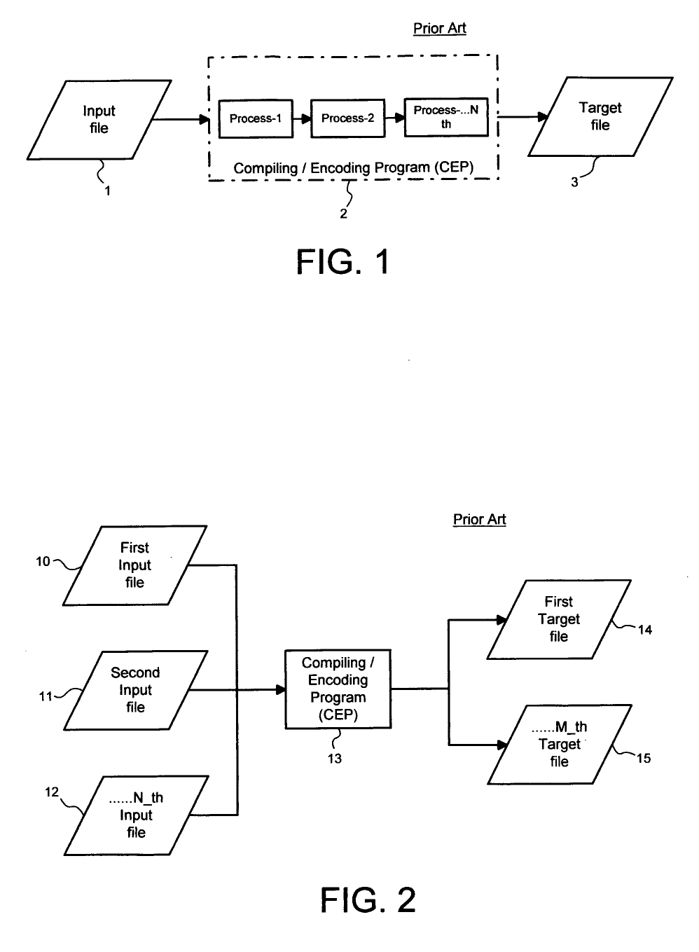

Described below, with reference to the block- and flow diagrams of FIGS. 1-8, are methods and preferred embodiments of systems according to the present invention, in various configurations. Generally, a system consists of two parts, one comprising an FMP and one—an AVP; in most cases the FMP part is used by the creator of the target files in one location and the AVP part is used by a verifying entity in another location.

FIG. 1 is a flow diagram that illustrates a CEP software 2 manipulating the information given in a single input file 1 and outputting a single target file 3, according to prior art. The CEP may comprise a plurality of processes in sequence—for example a compiler, a linker, a ciphering program or any other computer program. However, there is no simple way for anyone who gets both the input file 1 and the target file 3 to tell that the latter is a direct result of the former being processed by the CEP. It may appear like the authentic result when looking at some file attributes, like file header, time stamp etc., but all these can be easily manipulated to mislead the examiner.

Referring now to FIG. 2, a flow diagram of prior art illustrating a situation similar to that of FIG. 1 but with a plurality of input files 10, 11, 12 and a plurality of target files 14, 15. It will be apparent that the task of verifying that all target files are direct result of all the input files is practically impossible, because the input data are entirely altered by the CEP 13 and because data are divided and then integrated into multiple target files in an unknown manner.

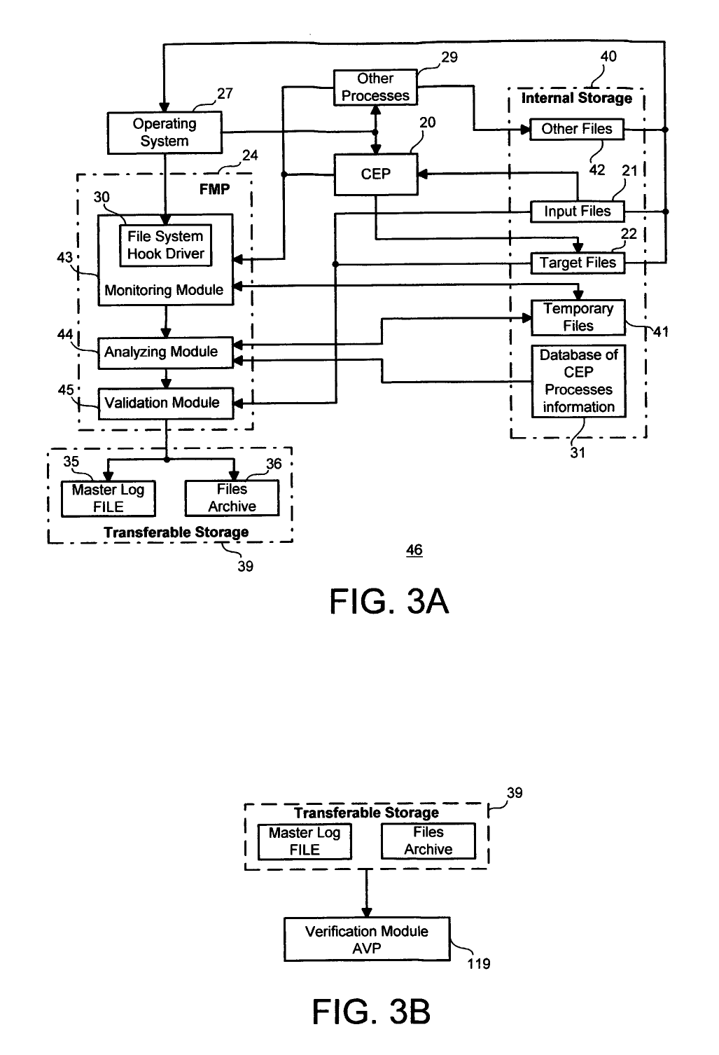

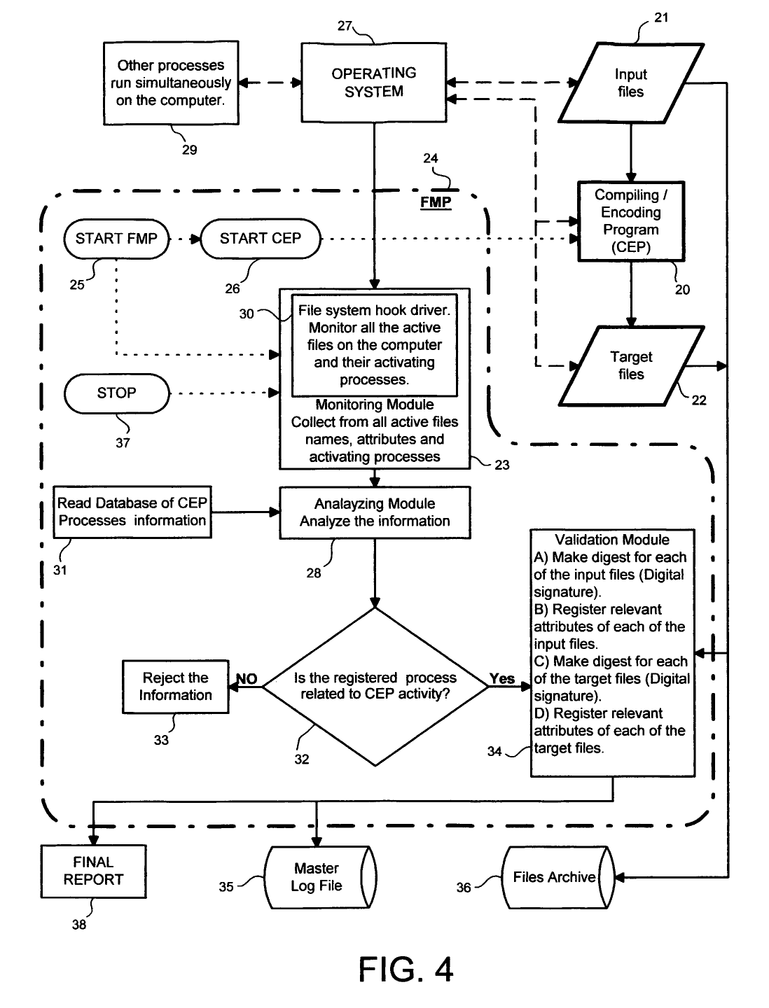

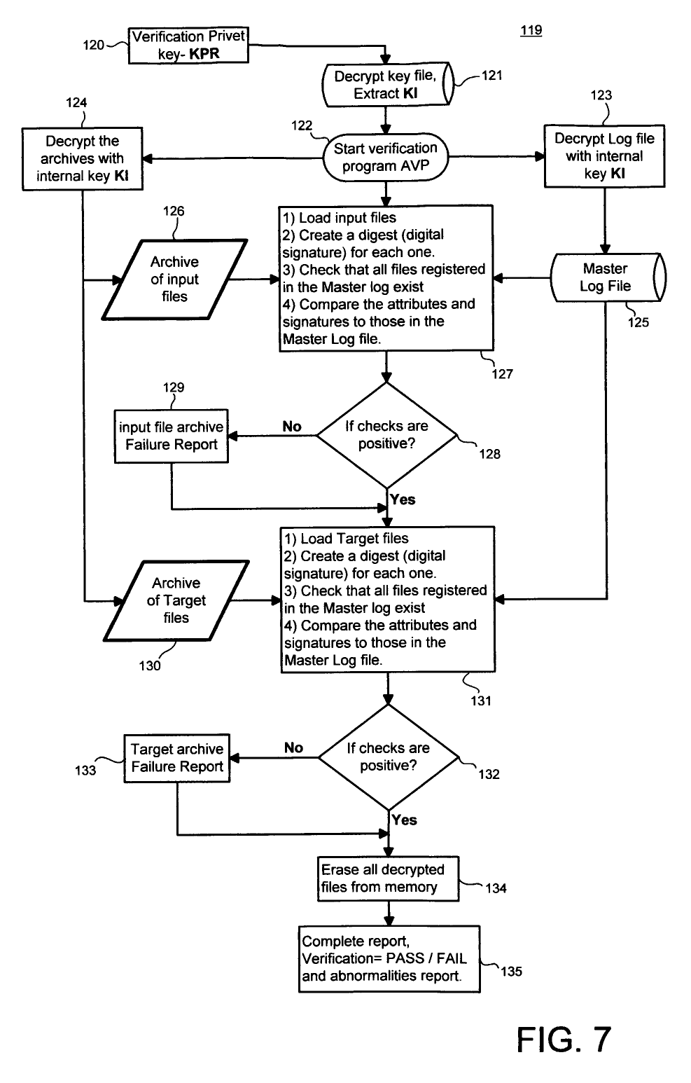

FIG. 3A is a block diagram, and FIG. 4—a flow diagram, of a preferred embodiment of a first aspect of the invention in a first configuration, as will be explained in greater detail hereinbelow. Shown in FIG. 3A is a host computer system 46, having an operating system 27 and a CEP 20 for creating target files 22 from input files 21, and a File Monitoring Program (FMP) 24, creating a files archive 36 and a master log file 35. The host system has generally also other processes 29 running concurrently with the CEP and using other files 42. Shown in addition are temporary files 41 and database of CEP information 31; all files reside on an internal storage 40 within the host system—either locally or remotely via communication network. The FMP 24 comprises monitoring module 43 with its “file system hook driver” 30, analyzing module 44 and validation module 45. The resulting files archive 36 and master log file 35 are copied to a transferable storage 39—e.g. tape, disc, DVD, removable memory device etc.—or sent via communicating network directly to a verifying entity. Said entity use the verification module (AVP) 119, shown in FIG. 3B and FIG. 7 and explained further below, to verify the integrity of the files.

The File Monitoring Program (FMP) 24 and the manner in which it authenticates and validates the input files and their linkage to the Compiling Encoding Program (CEP) will now be explained with reference to FIG. 3A and FIG. 4. The FMP monitors and analyzes all file related activities and processes done by the computer and subsequently authenticates the target files linkage to the input files. Illustrated is CEP 20 that has input of input files 21 and outputs plurality of target files 22. The CEP can be any computer program known in the art for example, compiler, linker, ciphering program, translation program, calculations program etc. The CEP is running under the control of an operating system 27, e.g. Windows, UNIX, Linux or any other system known in the art. Also, there are other unrelated processes 29 running concurrently on the same computer. In order to facilitate the monitoring and the authentication the operator first starts 25 the monitoring module 43 which activates a memory resident monitoring program 30, named “File system hook driver”. Said resident monitoring program 30 constantly receives information from the operating system 27 on all file activities and processes running on the computer. It specifically but not exclusively receives file commands, like open, close, read, write, erase, copy and move, all—together with their requesting process attributes specifically but not limited to path, name, time. After the FMP has been started the “start CEP” command 26 is issued manually or automatically and the CEP 20 starts operation. The FMP constantly monitors 23 every activity of every file and every process in the computer and registers the information into temporary files 41. It also analyzes 28 each activity according to a set of rules and parameters, present in the Database of CEP Processes 31, which contains, Inter alia, all CEP valid attributes and processes. Furthermore, it marks every activity as approved or not approved. The analyzed results are now tested 32 for relevancy to the CEP operation; if it is not relevant, i.e. it is part of any other process running on the computer at the same time and the files used are not connected in any way to CEP activity, then the information is rejected 33 and erased from the temporary files. However, if said information is relevant to CEP activity, the FMP registers the active file attributes information into a master log file 35. At the validation stage 34 the FMP calculates for each of the input and target files its digital signature and sorts its relevant attributes before registering it into log file 35 . It will be noted that the attributes and digital signature of the target files can only be calculated and registered after they were finished and closed by the creating CEP; therefore the FMP also monitors them after the CEP has finished operation and registers them to the master log file 35 before terminating itself. Furthermore, before the FMP terminates itself, Analyzing Module 44 analyzes 28 the usage and way of creation of each registered file according to the information logged in the temporary files 41 and data from the database of CEP processes 31 for workflow consistency, which processes accessed it, when and for what operation. If the FMP reveals that processes other than those which are part of the CEP also accessed the registered files they are marked “unapproved” and they are shown in report 38 with list of all files and clear warnings that certain files were handled by other programs during or after there usage by the CEP. Stop command 37 is used to terminate the FMP monitoring operation either manually by the operator or automatically from within the program.

To further clarify, according to this invention, the FMP tests are done to prevent any distortion of the input files after they have been used and of the target files during and after their creation by the CEP. Any intervention by processes other than those of the CEP or the operating system are considered suspicious and treated as such. Final report 38, with or without warnings, based on the approval or disapproval of each action and each file, is issued after every run of the FMP for user reference and archive management. Said report contains listing of all input files that participated and list of all target files. It will be further appreciated that the prove of and validation of the linkage between input files and target files lies in the master log file 35, created during the monitoring process and containing exclusive digital signatures and attributes of all files. After receiving a clean report, which shows no indication of abnormalities in the registered input and target files, the input and target files can be archived 36 and together with the master log file 35 stored on any removable media 39 or transmitted via communication net.

According to additional feature of the invention. The analyzing 28 and testing 32 procedures, described hereinabove can be executed concurrently with the operation of the CEP, i.e. “on the fly” or alternatively as post processing after all the information has been registered to temporary files and the CEP has finished. It is noted that in either option the FMP keeps its monitoring action until the last file has been validated and all the information has been registered to the master log file, in order to prevent any mishandling of the files.

Optionally, for saving processing time, the operator can point out the path to all the input files prior to CEP activation and the FMP will concurrently with its monitoring create digital signatures for all of them and register them directly to a temporary file. During the monitoring and analyzing processes the FMP will verify their usage and validity in same way described hereinabove.

It should be apparent to those skilled in the art that the usage of the system and method described hereinabove in FIG. 3A and FIG. 4 is suitable for an environment where there is no danger of intentional or unintentional interference or hackers attack. Otherwise, the registered information, target files and input files can be easily accessed and manipulated in ways that will render the whole authentication and validation process useless.

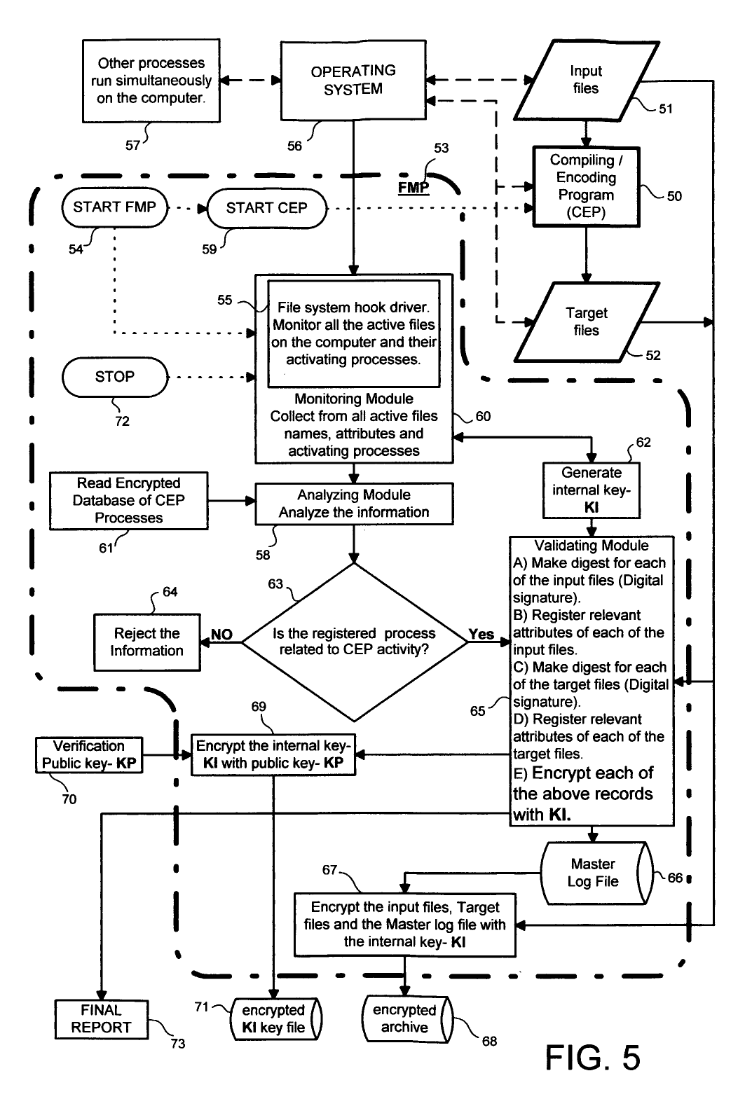

Referring now to FIG. 5, disclosed is an embodiment of the present invention in another configuration, comprising the FMP and an integrated two tiers encryption system, which prevents any intentional or unintentional interference with the authentication process or with the finished archive. According to an advantage of the present invention said archive can not be opened or verified by the CEP operator himself, but only by a second party holding a private key, thus allowing the latter not to be physically present in the same location where the target files are created and yet maintain absolute confidence in the results. As in the configuration of FIGS. 3A and 4, the FMP program 53 monitors and analyzes all file related activities and processes done by the computer and subsequently authenticates the target files linkage to the input files. Illustrated is CEP 50 that has input from input files 51 and outputs plurality of target files 52. The CEP can be any computer program known in the art for example, compiler, linker, ciphering program, translation program, calculations program etc. The CEP is running under the control of an operating system 56 e.g. Windows, UNIX, Linux or any other system known in the art. Also, there are other unrelated processes 57 running concurrently on the same computer. In order to facilitate the monitoring and the authentication the operator first starts 54 the FMP monitoring module which activates a memory resident monitoring program 55 named “File system hook driver”. It also creates an internal random symmetric ciphering key 62 and keeps it in a temporary memory location, not shown. Said resident monitoring program 55 constantly receives information from the operating system 56 on all file activities and processes running on the computer. It specifically but not exclusively receives file commands like open, close, read, write, erase, copy and move, all—together with their requesting process attributes specifically but not limited to path, name, time. After the FMP has been started the “start CEP” command 59 is issued manually or automatically and the CEP 50 starts operation. The FMP constantly monitors 60 every activity of every file and every process in the computer and encrypts the information using symmetric key 62 and registers the results into temporary files, not shown. It also analyzes 58 each activity according to set of rules and parameters present in an encrypted database of CEP processes 61 which contains, Inter alia, all CEP valid attributes and processes. Furthermore, it marks every activity as approved or not approved—all encrypted with an internal hard coded key, not shown. The analyzed results are now tested 63 for relevancy to the CEP operation; if it is not relevant, i.e. it is part of any other process running on the computer at the same time and the files used are not connected in any way to CEP activity, then the information is rejected 64 and erased from the temporary files, not shown. However, if the information is relevant to CEP activity, the Validation Module 65 calculates for each of the input and target files its digital signature and sort its relevant attributes. It, furthermore, encrypts the file information, using internal key 62, and registers it into a master log file 66. It will be noted that the attributes and digital signature of the target files can only be calculated and registered after they were finished and closed by the creating CEP; therefore the FMP also monitors them after the CEP has finished operation and registers them to the master log file 66 before terminating itself. Furthermore, before the FMP terminating itself, it analyze 58 the usage and way of creation of each registered file according to the information logged in the temporary files (not shown) and data from the encrypted database of CEP processes 61 for workflow consistency, which processes accessed it, when and for what operation. If the FMP reveals that processes other than those which are part of the CEP also accessed the registered files they are marked “unapproved” and they are shown in report 73 with list of all files and warnings for these certain files that were handled by other programs during or after their usage by the CEP. Immediately after, the FMP validates each of the input files 51 and each of the target files 52 against their respective digital signature in the master log file 66 and encrypts them 67 together with the master log file 66 into a single archive file 68, using internal key 62. Thereafter, the FMP requests the operator for the second-party public key 70, which is a part of a verification keys set issued by the verifying authority. The public key is used to encrypt 69 the internal symmetric key 62 and output an encrypted key file 71, that will be given, together with the encrypted archive 68, to the verifying authority. Stop command 72 is used to terminate the FMP monitoring operation either manually by the operator or automatically from within the program. Final report 73 is created as explained for FIG. 4 hereinabove.

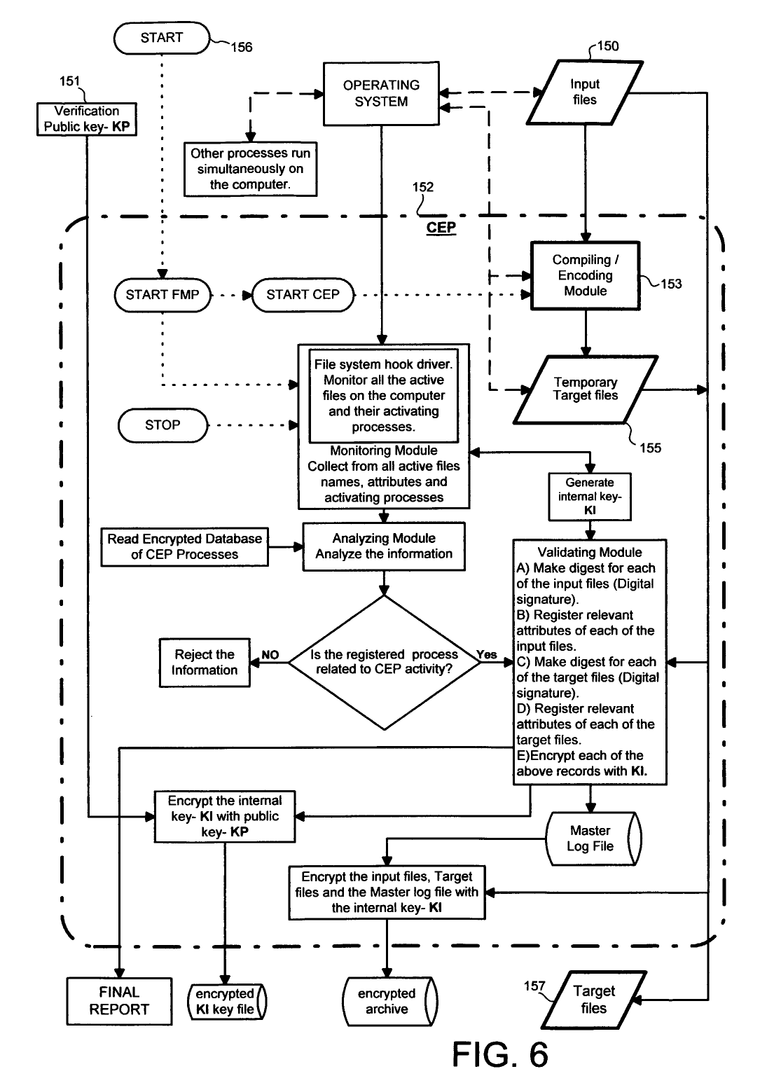

Referring now to FIG. 6, according to still another configuration of an embodiment of the present invention, the FMP can be an internal part of any CEP, such as a compiler, a linker, a translation program etc., and operate as integral part thereof, in order to achieve maximum reliability of the authentication and validation. There is shown in FIG. 6 a CEP software package 152 that includes a CEP module 153 and FMP modules. The operation is similar to that explained hereinabove with respect to FIG. 5, except for some minor changes, explained hereinafter. The operator first directs the CEP software to the input files 150 and inserts a verification public key 151, given to him by the verifying authority, then starts the system 156. During the operation stage, as described hereinabove the CEP, instead of directly creating the final target files, creates temporary target files 155 by its internal module 153. Only after said module has finished its activities and the FMP has finished creating the archive file, as explained hereinabove for FIGS. 4 and 5, then the FMP copies the temporary target files 155 to final target files 157 for delivery to the final user. It should be noted that in this configuration of the invention all this is done within a single program (the FMP being an integral part of the CEP) resulting in security enhancement and in that real-time manipulation of processes and files is prevented to a higher degree.

According to yet another configuration of an embodiment of the invention the FMP can be integrated into the operating system itself and function in the same manner as explained hereinabove with respect to FIG. 3A, FIG. 4, FIG. 5 and FIG. 6.

Referring now to FIG. 7—a flow diagram, and FIG. 3B—a block diagram, of a preferred embodiment of the second aspect of the invention. They show a Verification Module which is the Archives Verification Program (AVP) 119 that is used by the verifying authority to verify that input files given in an archive were actually the files used by a certain known CEP to create those given archived target files. Furthermore, it is used to verify that the input files were not changed, tempered with, damaged, add to etc. The AVP 119 can handle archives like those resulted from any of the processes explained hereinabove with respect to FIGS. 4, 5 and 6. The verification operator decrypts the key file 121, if any, by using his private key 120, and extracts a symmetric key, which is then fed to the AVP and starts the program 122. The AVP decrypts and extract 123 the master log file 125 and decrypts the archive file 124, extracting input files 126 and target files 130. All files 125, 126, and 130 are placed in a location within the computer's memory (not shown). Now the AVP performs verification 127 on each input file in the archive 126 by comparing each attribute registered in the master log file 125 to the actual attribute of the file in the archive. If a mismatch is encountered 128, the program registers the problematic file in a failure report 129. After all input files have been checked, the program checks in a similar way 131, 132 and 133, the target files 130 in the archive. Before terminating, the AVP erases all decrypted files 134 from memory and issues a comprehensive result report 135.

It will be apparent that for unencrypted archives the process remains the same, except for the use of the keys and decryption stages.

Optionally in some cases the creator of the target files may give a copy of them directly to the customer, as, for example, in the case of the final software executables, while at the same time sending the archive file to a verifying authority. In such cases, the verifying authority can obtain the customer's copy and, by means of simple bit to bit comparison with the archived files, authenticate its origin.

In another configuration of the second aspect of the present invention, the AVP (verification module) can be integrated into the operating system itself and function in the same manner as explained hereinabove.

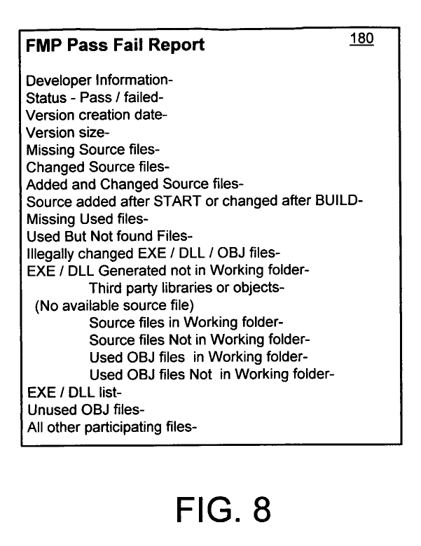

Referring now to FIG. 8, illustrated, by way of example, a final report 180, (e.g. 38 in FIG. 4), for compiler monitoring. In said report are listed general developer information, pass/fail, extraordinary events that were detected during the run and all type of files used or created in a compiling process. Such a report gives the examiner complete picture of the participating files and their usage. A similar report can be obtained also from the AVP.

1-29. (canceled)

30) A system for authenticating and validating the linkage between input files and output target files of a given computational process, the system comprising:
a monitoring module, for monitoring and registering all file operations and active processes on the host computer;
an analyzing module, for analyzing the collected information relevancy and authenticating the linkage between the preferred computational process and active files; and
a validating module, for creating digital signature for each authenticated file, registering its attributes and storing said signatures and attributes, together with the input files and the output target files, in an archive.

31) The system according to claim 30, wherein the monitoring module continually receives information from the operating system regarding all current file operations on the computer.

32) The system according to claim 30, wherein the monitoring module continually receives information from the operating system regarding all current processes running on the computer.

33) The system according to claim 31, wherein the monitoring module has a memory resident driver.

34) The system according to claim 31, wherein the monitoring module resides in an auxiliary electronic circuitry.

35) The system according to claim 31, wherein the collected information is stored in plurality of temporary files.

36) The system according to claim 30, wherein said analyzing module comprises an analyzing method for analyzing the relevancy of the collected information

37) The method according to claim 36, comprising the steps of: retrieving file and processes information from the temporary files; retrieving information from database of computational processes information, matching for each file its activating process; authenticating that the files were handled by the appropriate computational process; and
examining all the authenticated files for access by processes other then the monitored given computational process.

38) The method according to claim 36, further comprising the step of concurrently creating digital signature for said authenticated files.

39) The method according to claim 36, further comprising the step of concurrently saving digital signature and other file attributes to a file.

40) The system according to claim 30, wherein said validating module comprises a validation method for detecting illegal manipulation of the input and output target files.

41) The method according to claim 40, comprising the steps of: retrieving information from temporary files; creating file digital signature; checking for each file its attributes and processes; validating that the files were handled only by the appropriate computational process and were not changed after that; and saving the digital signatures and other file attributes to a master log file.

42) The method according to claim 40, further comprising the step of issuing a warning report for any file accessed by processes other then the monitored given computational process.

43) The system according to claim 30, comprising an archiving process.

44) The system according to claim 43, wherein the input files, output target files and master log file are automatically archived together.

45) The system according to claim 30, comprising data encryption.

46) The system according to claim 45, wherein the encryption key is a random internally generated symmetric key.

47) The system according to claim 45, wherein the encryption key is encrypted by an externally imported public key for safekeeping.

48) The system according to claim 30, wherein said system is integrated into the given computational software.

49) The system according to claim 30, wherein said system is integrated into the computer operating system.

50) The system according to claim 30, wherein result reports are issued.

51) The system according to claim 50, wherein said reports contain lists of all authenticated participating files and their attributes.

52) The system according to claim 30, further comprising A verification method for verifying the consistency and validity of the archive.

53) The verification method according to claim 52, comprising the steps of: providing an archive, retrieving archived input files; retrieving archived output target files; retrieving archived master log file, and comparing the attributes registered in the log file to the actual attributes of the retrieved files.

54) The method according to claim 52, further comprising the step of decrypting the archive files.

55) The method according to claim 52, further comprising the step of issuing results report.

56) The system according to claim 30, further comprising the variations described in the detailed description section of the present invention.

57) The system according to claim 30, further comprising the variations described in the drawings section of the present invention.

58) A method for authenticating and validating the linkage between input files and output target files of a given computational process, the method comprising: monitoring and registering all file operations and active processes on the host computer; analyzing the collected information for relevancy and authenticating the linkage between the preferred computational process and active files, and creating digital signature for each authenticated file, registering its attributes and storing said signatures and attributes, together with the input files and the output target files, in an archive.
